(19) United States
(12) Patent Application Publication
(10) Pub. No.: US 2026/0341947 A1
(43) Pub. Date: Oct. 29, 2026

(54) TRANSFORMER-BASED COUPLER WITH ENHANCED COUPLING STRENGTH

(71) Applicant: Dell Products L.P., Round Rock, TX (US)

(72) Inventors: Tejinder Singh, Manotick (CA); Navjot Kaur Khaira, Manotick (CA)

(21) Appl. No.: 19/189,210

(22) Filed: Apr. 24, 2025

(51) Int. Cl. H01P 5/16; H01F 27/28

(52) U.S. Cl. CPC H01P 5/16; H01F 27/2804

(57) ABSTRACT

The technologies described herein are directed towards a transformer-based quadrature coupler suitable for high radio frequency (RF) signals. In one implementation, the transformer-based quadrature coupler is based on a three-metal layer design with four planar coils at an upper metal layer, and two planar coils at a lower metal layer. Parts of the upper metal layer planar coils overlap with portions of the lower metal layer coils. A middle metal layer includes metal strips, including between the overlapping regions, which facilitates higher coupling efficiency and consistent bandwidth in the transformer-based quadrature coupler. In one implementation, the quadrature coupler is fabricated on a substrate via conventional printed circuit board techniques. Such a quadrature coupler design achieves a balance between compact size and efficient performance, operating efficiently in the 5-6 gigahertz range, whereby the quadrature coupler device is suitable for a wide range of commercial and industrial wireless systems.

### BACKGROUND

Quadrature couplers are components used in radio frequency (RF) systems, facilitating the efficient division and combination of signals with precise phase relationships. They are commonly used for applications such as signal splitting, mixing, and beamforming in RF communication systems. Common types of such couplers include branch-line couplers, Lange couplers, and hybrid couplers. Each type is characterized by its compactness, bandwidth, and phase accuracy, with trade-offs in design complexity and performance.

Quadrature couplers are also used in Wi-Fi systems for power division in antennas, combining signals in beamforming networks, phase shifting, and implementing modulation and demodulation in transceivers, while being able to improve signal integrity and achieve high data rates in advanced Wi-Fi technologies. Wideband couplers operate across broad frequency ranges, useful for multiband systems, while narrowband couplers are designed for specific frequency ranges, offering high performance with respect to insertion loss, isolation, and phase accuracy; narrowband couplers are commonly used in single-band applications like Wi-Fi transceivers or dedicated RF channels.

### BRIEF DESCRIPTION OF THE DRAWINGS

The technologies described herein are illustrated by way of example and not limited in the accompanying figures in which like reference numerals indicate similar elements and in which:

FIG. 1 is a top view representation of a layout of an example multilayered transformer-based quadrature coupler for radio frequency (RF) signals, showing metal layers and interconnects, in accordance with various embodiments and implementations of the subject disclosure.

FIG. 2 is a top view representation of the example multilayered transformer-based quadrature coupler of FIG. 1 showing the various metal layers including different sections containing overlapping planar coils, in accordance with various embodiments and implementations of the subject disclosure.

FIG. 3A is a block diagram representation of an example transformer-based quadrature coupler showing different sections between the quadrature coupler ports, in accordance with various embodiments and implementations of the subject disclosure.

FIG. 3B is a circuit representation of an example transformer-based quadrature coupler showing transformer based coupling in the different sections, in accordance with various embodiments and implementations of the subject disclosure.

FIG. 4 is a three-dimensional (3D) perspective top and side view corresponding to the example multilayered transformer-based quadrature coupler of FIG. 1 showing the various metal layers, in accordance with various embodiments and implementations of the subject disclosure.

FIG. 5 is a 3D perspective top and side view corresponding to the example multilayered quadrature coupler of FIG. 1 deployed as a device on a substrate, in accordance with various embodiments and implementations of the subject disclosure.

FIG. 6 is a 3D perspective top and side view corresponding to the middle metal layer of the example multilayered quadrature coupler of FIG. 1 above a substrate, in accordance with various embodiments and implementations of the subject disclosure.

FIG. 7 is a 3D perspective top and side view highlighting the separations of the top, middle and bottom layers of the example multilayered quadrature coupler of FIG. 1, in accordance with various embodiments and implementations of the subject disclosure.

FIG. 8 is a graphical representation of simulated response of the S-parameters of the example quadrature coupler designed with around a 1 GHz bandwidth and between around a 5 and 6 GHz frequency, in accordance with various embodiments and implementations of the subject disclosure.

FIG. 9 is a graphical representation of simulated phase response of the example quadrature coupler showing a ninety-degree phase response between about 4.6 and 6.6 gigahertz, in accordance with various embodiments and implementations of the subject disclosure.

FIG. 10 is a representation of a schematic/block diagram of a Butler matrix that includes example quadrature couplers as described herein, in accordance with various example embodiments and implementations of the subject disclosure.

### DETAILED DESCRIPTION

The technology described herein is generally directed towards a transformer-based quadrature hybrid coupler configured in a multilayer topology, in which the coupling strength is enhanced by integrating middle-layer metal strips to improve. The top layer includes first and third sections with four planar coils coupled to the ports of the quadrature coupler, while the bottom section includes two planar couplers that complete the transformer-based operation. Designed for operation within the 5-6 GHz frequency range, the coupler can be implemented using standard printed circuit board technology, ensuring cost-effectiveness and compatibility with existing manufacturing processes.

Note that conventional quadrature couplers face limitations in achieving compact size, strong coupling, and cost-effective fabrication. Transformer-based couplers often require complex manufacturing processes or exotic materials, making them unsuitable for widespread deployment. In contrast the technologies described herein deliver consistent performance in higher-frequency bands, particularly within the 5-6 GHz range, appropriate for many radio frequency (RF) and wireless applications.

Indeed, existing transmission line-based couplers can provide wideband performance but are large and unsuitable for compact systems, while lumped-element designs offer smaller form factors but lack adequate bandwidth and coupling strength. Standard commercial off-the-shelf solutions lack the customization and performance optimization appropriate for many modern applications and usage scenarios. Commercially available couplers also are often expensive, which can significantly increase the cost of the systems in which they are used. Commercially available couplers are also bulky, whereby if a system needs multiple couplers, the size and weight limitation pose implementation challenges.

It should be understood that any of the examples and/or descriptions herein are non-limiting. Thus, any of the embodiments, example embodiments, concepts, structures, functionalities or examples described herein are non-limiting, and the technologies may be used in various ways that provide benefits and advantages in communications and computing in general.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. For example, “optimal” placement of a subnet means selecting a more optimal subnet over another option, rather than necessarily achieving an optimal result. Similarly, “maximize” means moving towards a maximal state (e.g., up to some processing capacity limit), not necessarily achieving such a state, and so on.

It will also be understood that when an element such as a layer, region or substrate is referred to as being “on” or “over” “atop” “above” “beneath” “below” “between” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

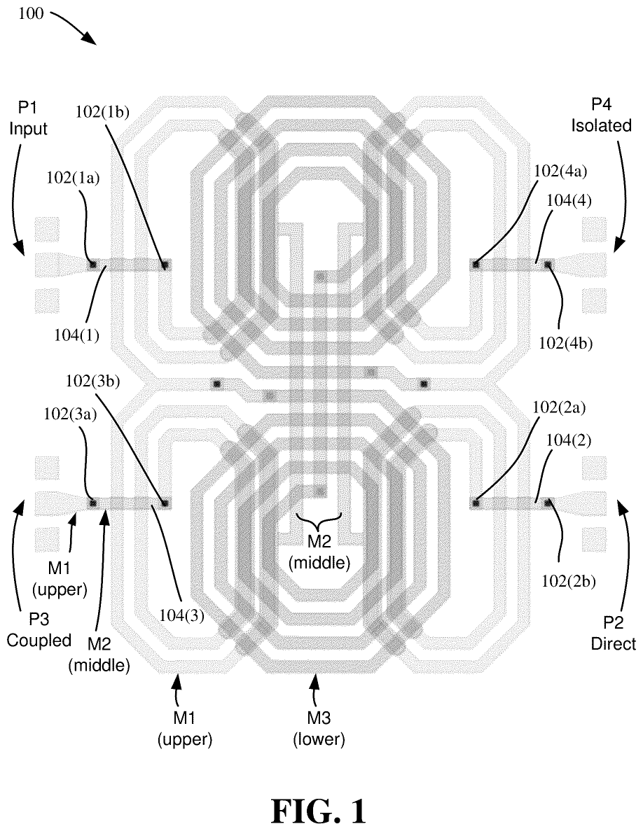

FIG. 1 shows a top view of an example transformer-based quadrature coupler 100 including a top metal layer M_upper, a middle metal layer M_middle, and a bottom metal layer M_lower. In this example implementation, the top metal layer M_upper includes RF ports P1 (input), P2 (direct, or through), P3, (coupled) and P4 (isolated). The ports P1-P4 are connected by an upper level of planar coils. The middle metal layer M_middle includes a number of metal strips as described herein, configured to enhance coupling while reducing interference. The bottom metal layer M_lower includes a lower level of planar coils. In general, an RF signal input to Port P1 (input port) is split by the transformer-based quadrature coupler 100, with a first instance of the signal obtained at Port 3 (direct, or through port), with Port 3 (coupled port) receiving a phase-shifted (e.g., typically ninety degrees) second instance of the RF signals. Port 4 is the isolated port that is typically terminated.

The second layer comprises interconnects and metal strips therebetween, including a first interconnect 102(1a) coupled to the first port and a second interconnect 102(1b) coupled to an inner end of a first coil, with a metal strip 104(1) between the first interconnect and the second interconnect. The other interconnects are similar pairs labeled 102(2a) and 102(2b), 102(3a) and 102(3b), and 102(4a) and 102(4b), with the pairs coupled together by metal strips 104(2), 104(3) and 104(4), respectively.

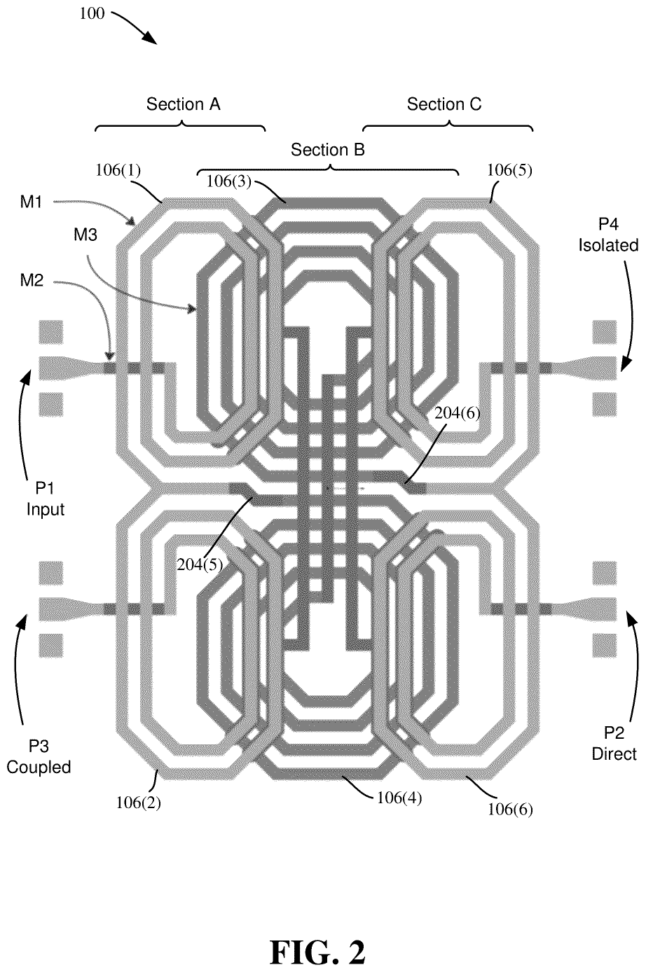

FIG. 2 shows a first section A on the upper metal later M1, including a first planar coil 106(1) and a second planar coil 106(2), and a third section C on the upper metal later M1, including a fifth planar coil 106(5) and a sixth planar coil 106(6). A second section B includes a third planar coil 106(3) and a fourth planar coil 106(4). As can be seen, the first planar coil 106(1) includes a part that overlaps with and is inductively coupled to a portion of the third planar coil 106(3). The fifth planar coil 106(5) includes a part that overlaps with and is inductively coupled to another portion of the third planar coil 106(3). The second planar coil 106(2) includes a part that overlaps with and is inductively coupled to a portion of the fourth planar coil 106(4). The sixth planar coil 106(6) includes a part that overlaps with and is inductively coupled to another portion of the fourth planar coil 106(4).

Further, the outer end of the first planar coil 106(1) is coupled to the outer end of the second planar coil 106(2), and these outer ends are coupled via a metal strip 204(5) on the middle layer to the fourth planar coil 106(4). The outer end of the fifth planar coil 106(5) is coupled to the outer end of the sixth planar coil 106(6), and these outer ends are coupled via a metal strip 204(6) on the middle layer to the third planar coil 106(3).

In one implementation, the first and third portions are identical, that is, the first planar coil mirrors the fifth planar coil in a first dimension (horizontal in FIG. 2) between the first RF port and the fourth RF port, the first planar coil mirrors the second planar coil in a second dimension (vertical in FIG. 2) that is perpendicular to the first dimension, the sixth planar coil mirrors the second planar coil in the first dimension, wherein the first planar coil mirrors the second planar coil in the first dimension, and the sixth planar coil mirrors the fifth planar coil in the second dimension. Also, in this example implementation the third planar coil mirrors the fourth planar coil in the second dimension.

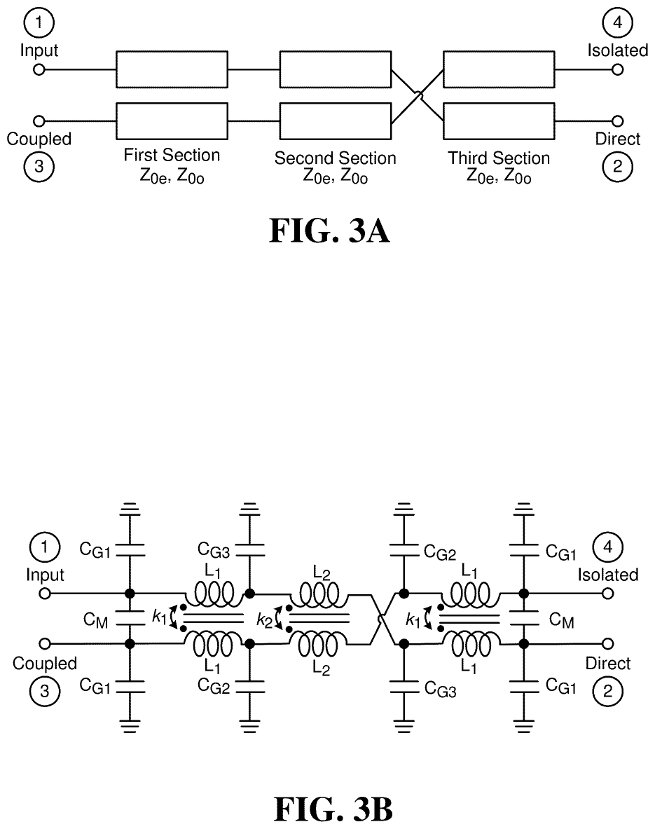

FIG. 3A is a block diagram of the three sections, and FIG. 3B is a circuit diagram representation of the transformer-based coupling within the three sections. The various values of the components' parameters are determined by:

$${Z}_{0} = \sqrt{{Z}_{0 e} {Z}_{0 o}} ,$$

$$k = \frac{{Z}_{0 e} - {Z}_{0 o}}{{Z}_{0 e} + {Z}_{0 o}} ,$$

$$L = \frac{{Z}_{0}}{\sqrt{{ω}^{2} ( 1 - {k}^{2} )}} ,$$

$${C}_{M} = \frac{k}{\sqrt{{Z}_{0}^{2} {ω}^{2} ( 1 - {k}^{2} )}} ,$$

$${C}_{G} = \frac{1 - k}{\sqrt{{Z}_{0}^{2} {ω}^{2} ( 1 - {k}^{2} )}} .$$

The following table, TABLE 1, shows example values of the parameters:

TABLE 1

| | | |
|---|---|---|
| Parameter | Section A and C | Section B |

| | | | | |
|---|---|---|---|---|
| Even-Mode, Z₀ₑ | 68.5 | Ω | 164.2 | Ω |
| Odd-Mode, z₀ₒ | 44.4 | Ω | 12.7 | Ω |

| | | |
|---|---|---|
| Coupling, k | 0.122 | 0.973 |

| | | | | |
|---|---|---|---|---|
| Inductance, L | 0.8 | nH | 2.7 | nH |

| | | | |
|---|---|---|---|
| Capacitor, Cₐ | 1.2 | fF | 0.9 fF, 0.8 fF |
| Capacitor, C_{b} | 1.2 | fF | NA |

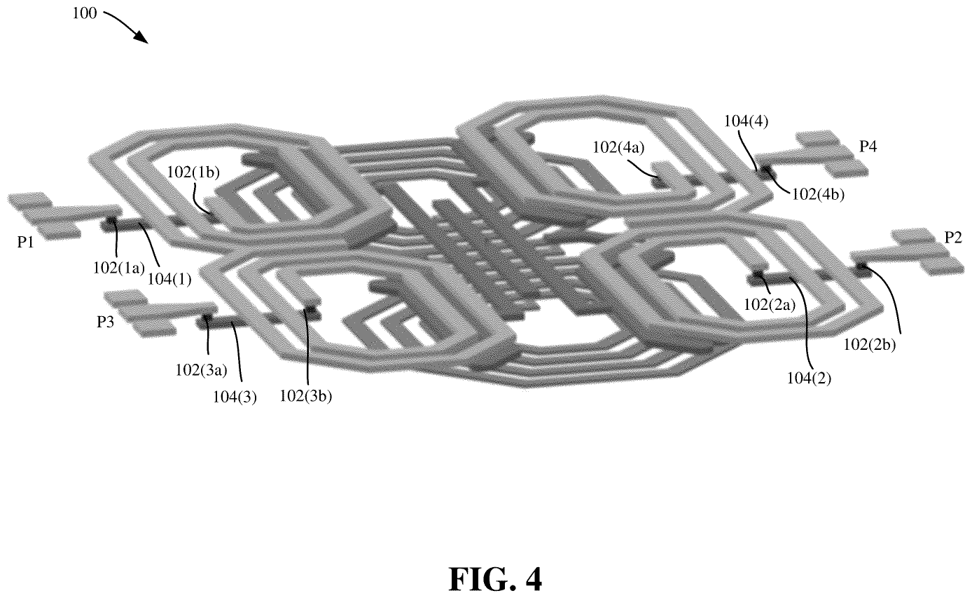

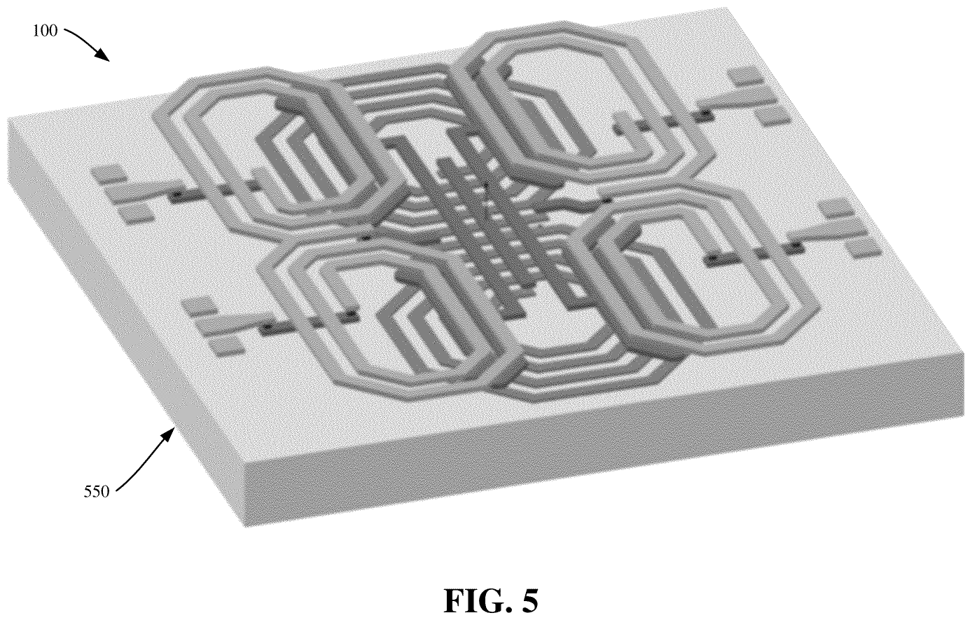

FIG. 4 is a three-dimensional (3D) view corresponding to the transformer-based quadrature coupler 100 of FIGS. 1 and 2. The interconnects 102(1a)-102(4b) shown in FIG. 1 are similarly labeled in FIG. 4, although some are only partially visible. The metal strips 104(1)-104(4) between the interconnects are also similarly labeled. FIG. 5 shows the quadrature coupler 100 deployable as a device fabricated on a substrate 550.

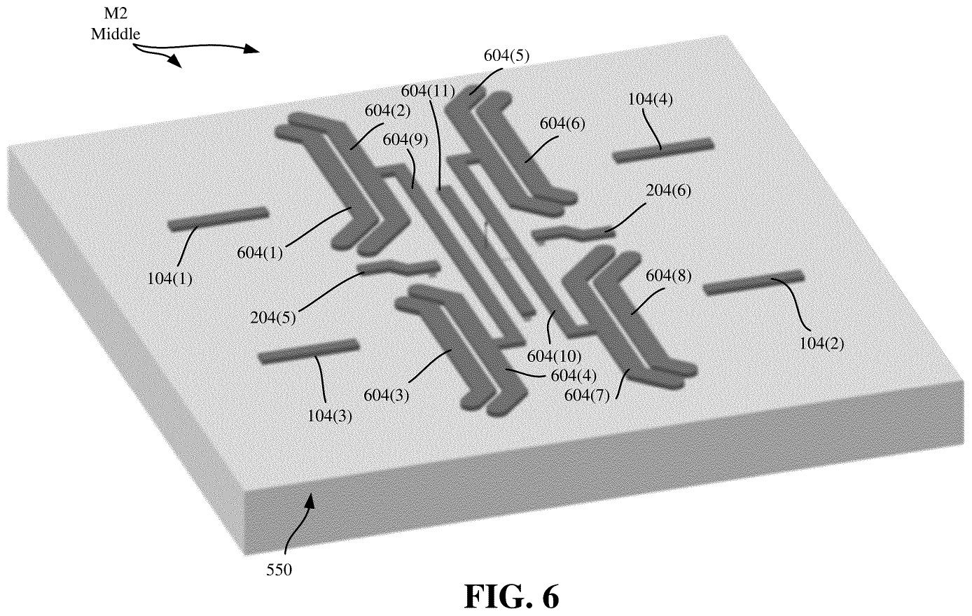

FIG. 6 shows the various strips of the middle metal layer M2, including the upper layer to the middle layer interconnecting strips 104(1)-104(4) and the middle layer to the lower layer interconnecting strips 204(5) and 204(6). There are also ten non-interconnecting (with respect to the interconnections between different levels of the metal layers) strips 604(1)-604(10), including a first non-interconnecting strip 604(1) paired with a second non-interconnecting strip 604(2), a third non-interconnecting strip 604(3) paired with a fourth non-interconnecting strip 604(4), a fifth non-interconnecting strip 604(5) paired with a sixth non-interconnecting strip 604(2), and a seventh non-interconnecting strip 604(7) paired with an eighth non-interconnecting strip 604(2). The non-interconnecting strips also include a ninth non-interconnecting strip 604(9) that electrically couples the second non-interconnecting strip 604(2) to the fourth non-interconnecting strip 604(4), and a tenth non-interconnecting strip that electrically couples the fifth non-interconnecting strip 604(5), to the non-interconnecting seventh strip 604(7).

There is also an eleventh strip 604(11) positioned at the second metal layer between the ninth non-interconnecting strip 604(9) and the tenth non-interconnecting strip 604(10), which inductively couples the ninth non-interconnecting strip 604(9) to the tenth non-interconnecting strip 604(10). The eleventh strip 604(11) is an interconnecting strip that electrically couples the inner end of the third planar coupler 106(4) to the inner end of the fourth planar coupler 106(4) (FIG. 2).

Note that the first non-interconnecting strip 604(1) paired with the second non-interconnecting strip 604(2) are in between the part of the first coil that overlaps the portion of the third coil, as generally shown in FIG. 2. The other paired non-interconnecting strips similarly are between other overlapping coil parts and portions. These middle-layer metal strips significantly improve coupling strength in the transformer-based coupler 100, a feature that addresses limitations in conventional designs. Operating efficiently within the 5-6 GHZ frequency range, the transformer-based coupler 100 leverages standard printed circuit board technology, making it both cost-effective and accessible for broad deployment. By introducing the middle layer metal strips, the design achieves high coupling efficiency and consistent bandwidth without relying on specialized or expensive fabrication techniques like GaAs processes. This approach offers a practical and manufacturable solution that balances performance, size, and cost, making it suitable for modern RF and wireless communication applications.

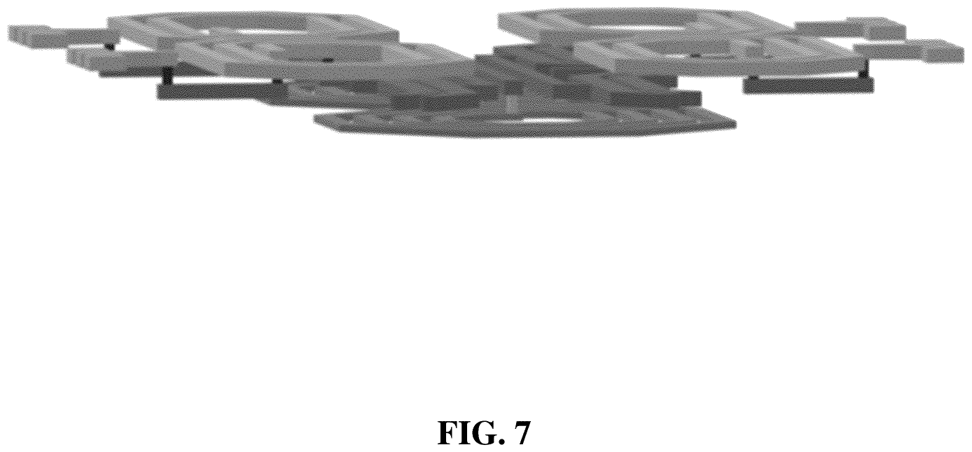

FIG. 7 is a 3D view that shows the separation between the layers. Some of the interconnecting couplers are visible in FIG. 7.

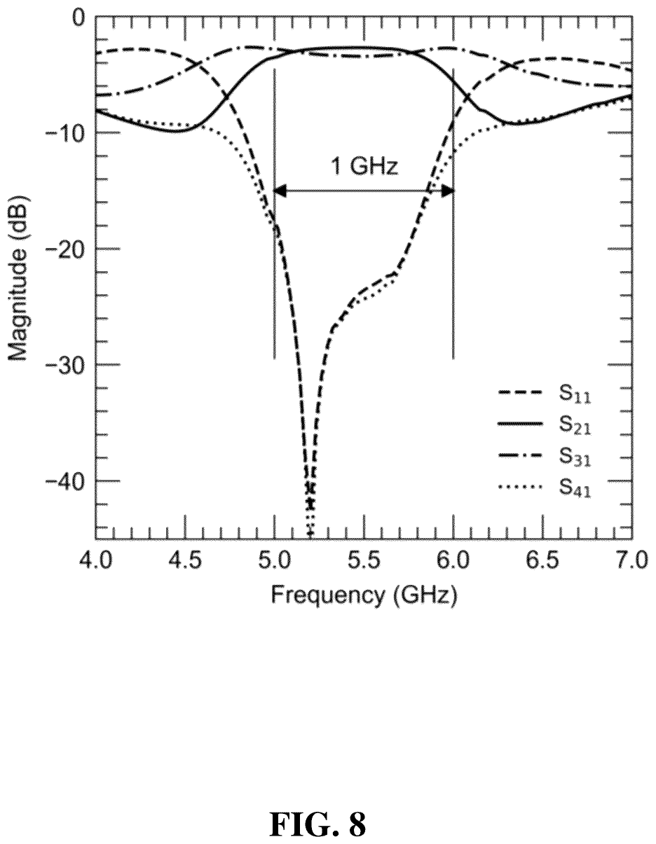

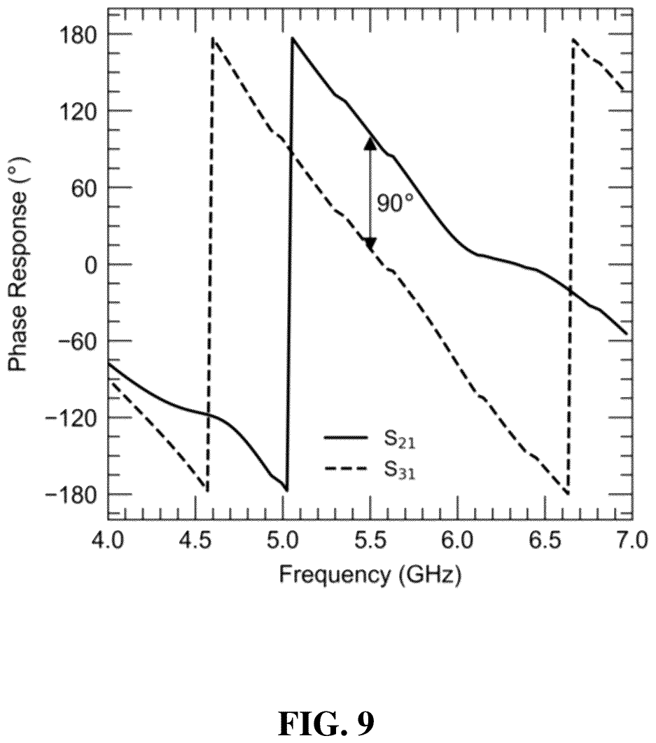

Metrics for couplers include insertion loss, phase accuracy (e.g., maintaining precise 90 degrees phase difference between outputs), coupling factor, and isolation (minimizing signal leakage between ports). FIG. 8 is a graphical representation of simulated response of the example quadrature coupler generally designed based on a 1 GHz bandwidth around a 5.5 GHz center frequency. FIG. 8 shows the magnitudes (in dB) of the S-parameters S₁₁, S₂₁, S₃₁ and S₄₁ for a frequency range from about 4 GHz to about 7 GHz. FIG. 9 is a graphical representation of simulated phase response of the example quadrature coupler in degrees (°) for the same design over the same frequency range, showing a phase difference between S₂₁ and S₃₁.

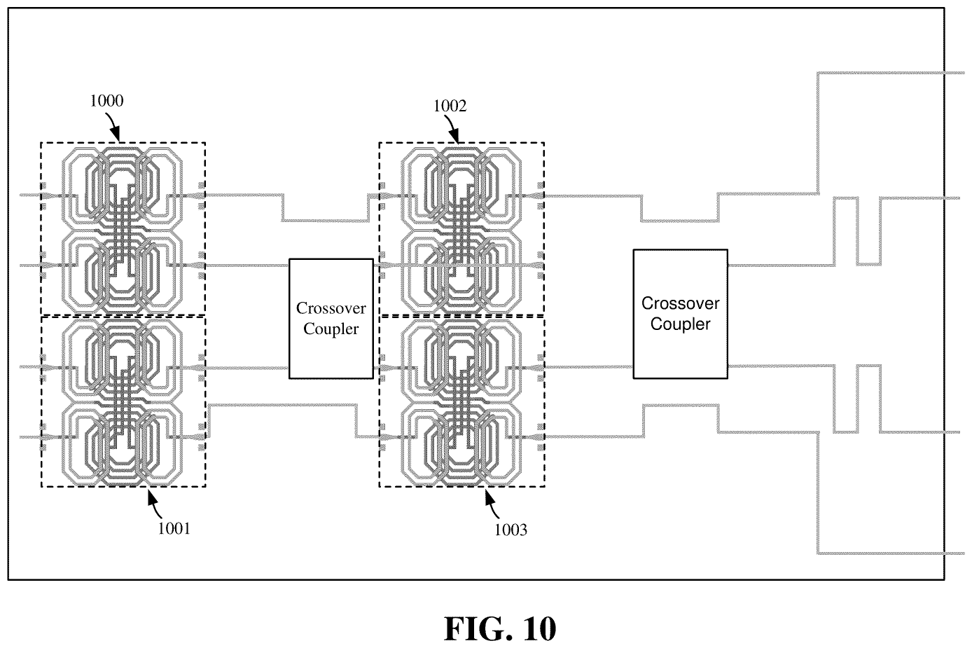

With respect to quadrature coupler uses, in high frequency communication systems, quadrature couplers based on the example design described herein can be used in a Butler matrix. The example of FIG. 10 shows four quadrature couplers 1000-1003 as described herein incorporated into a Butler matrix beamforming network.

To summarize, the transformer-based quadrature coupler described herein leverages a straightforward three-layer design that is compatible with standard manufacturing processes, making the transformer-based quadrature coupler cost-effective and scalable for modern applications. The design incorporates precise impedance calculations to facilitate optimal performance, and employs second and third metal layers to enhance coupling between layers, significantly widening the operational bandwidth.

One or more example embodiments and/or implementations can be embodied in a quadrature coupler, such as described and represented herein. The quadrature coupler can include a first radio frequency (RF) port, a second RF port, a third RF port, and a fourth RF port, and an upper metal layer, a lower metal layer, and a middle metal layer between the upper metal layer and the lower metal layer. The quadrature coupler can include a first section, including a first planar coil on the first metal layer, the first coil planar coil including a first inner end and a first outer end, in which the first planar coil is coupled to the first port via a first interconnected portion of the second metal layer, and a second planar coil on the first metal layer, the second coil planar coil including a second inner end and a second outer end, in which the first planar coil is electrically coupled to the second planar coil at the first outer end of the first planar coil and the second outer end of the second planar coil, and in which the second planar coil is coupled to the third port via a second interconnected portion of the second metal layer. The quadrature coupler can include a third section, including a fifth planar coil on the first metal layer, the fifth coil planar coil including a fifth inner end and a fifth outer end, in which the fifth planar coil is coupled to the fourth port via a fifth interconnected portion of the second metal layer, and a sixth planar coil on the first metal layer, the sixth coil planar coil comprising a sixth inner end and a sixth outer end, in which the fifth planar coil is electrically coupled to the sixth planar coil at the fifth outer end of the fifth planar coil and the sixth outer end of the sixth planar coil, and in which the sixth planar coil is coupled to the second port via a sixth interconnected portion of the second metal layer. The quadrature coupler can include a second section, including a third planar coil on the third metal layer, the third planar coil including a third inner end and a third outer end, in which the third outer end of the third planar coil is electrically coupled to the fifth outer end of the fifth planar coil and the sixth outer end of the sixth planar coil via a seventh interconnected portion of the second metal layer, and a fourth planar coil on the third metal layer, the fourth planar coil including a fourth inner end and a fourth outer end, in which the fourth outer end of the fourth planar coil is electrically coupled to the first outer end of the first planar coil and the second outer end of the second planar coil via a third interconnected portion of the second metal layer, and in which the third inner end of the third planar coil is electrically coupled to the fourth inner end of the fourth planar coil via a fourth interconnected portion of the second metal layer. The first planar coil overlaps and is inductively coupled to the third planar coil at a first overlapping region, and wherein a first non-interconnected portion of the second metal layer and a second non-interconnected portion of the second metal layer are between the first planar coil and the second planar coil at the first overlapping region. The second planar coil overlaps and is inductively coupled the fourth planar coil at a second overlapping region, and a third non-interconnected portion of the second metal layer and a fourth non-interconnected portion of the second metal layer are between the second planar coil and the fourth planar coil at the second overlapping region. The fifth planar coil overlaps and is inductively coupled to the third planar coil at a third overlapping region, and a fifth non-interconnected portion of the second metal layer and a sixth non-interconnected portion of the second metal layer are between the fifth planar coil and the third planar coil at the third overlapping region. The sixth planar coil overlaps and is inductively coupled the fourth planar coil at a fourth overlapping region, and a seventh non-interconnected portion of the second metal layer and an eighth non-interconnected portion of the second metal layer are between the sixth planar coil and the fourth planar coil at the second overlapping region. The second non-interconnected portion of the second metal layer is electrically coupled to the sixth non-interconnected portion of the second metal layer and, and the third non-interconnected portion of the second metal layer is electrically coupled to the seventh non-interconnected portion of the second metal layer.

The first section can be substantially identical to the third section.

The first RF port can be an input port, the second RF port can be a direct port, the third RF port can be a coupled RF port, and the fourth RF port can be an isolated RF port.

The second metal layer can be below the first metal layer level, and the third metal layer level can be below the second metal layer level.

The first section can have an even mode impedance around 68.5 ohms, and an odd mode impedance around 44.4 ohms, and the second section can have an even mode impedance around 164.2 ohms, and an odd mode impedance of about 12.7 ohms.

The first section can have a coupling coefficient around 0.122, and the second section can have a coupling coefficient of about 0.973.

The first section can have an inductance around 0.8 nanohenries, and wherein the second section can have an inductance of about 0.2.7 nanohenries.

The first section can have a ground capacitor having a first capacitance around 1.2 femtofarads, and can have a mutual coupling capacitor having a second capacitance of about 0.8 or 0.9 femtofarads.

The second section can have a capacitance of about 1.3 femtofarads.

The quadrature coupler can have a bandwidth of about one gigahertz.

The quadrature coupler can have as a center frequency between about five and six gigahertz.

The quadrature coupler can be incorporated into a Butler matrix.

One or more example embodiments and/or implementations can be embodied in a device, such as described and represented herein. The device can include a substrate, a first metal level, a second metal level and a third metal level above the substrate, and an RF quadrature coupler. The RF quadrature coupler can include a first RF port, a second RF port, a third RF port, and a fourth RF port, and a first planar coil, a second planar coil, a fifth planar coil and a sixth planar coil on the first metal level. The first planar coil can be coupled to the first port, the second planar coil can be coupled to the third port, and the first planar coil can be coupled to the second planar coil. The fifth planar coil can be coupled to the fourth port, the sixth planar coil can be coupled to the second port, and the fifth planar coil can be coupled to the sixth planar coil. The RF quadrature coupler can include a third planar coil and a fourth planar coil on the third metal level. The third planar coil can be coupled to the fourth planar coil via a first coupling of the second metal layer, the fourth planar coil can be coupled to the first planar coil and the second planar coil via a second coupling of the second metal layer, and the third planar coil can be coupled to the fifth planar coil and the sixth planar coil via a third coupling of the second metal layer. A first part of the first planar coil overlaps and inductively couples to a first portion of the third planar coil, and a second part of the fifth planar coil overlaps and inductively couples to a second portion of the third planar coil. A third part of the second planar coil overlaps and inductively couples to a third portion of the fourth planar coil, and a fourth part of the sixth planar coil overlaps and inductively couples to a fourth portion of the fourth planar coil. A first set of strips of the second metal layer can be between the first part of the first planar coil and the first portion of the third planar coil, a second set of strips of the second metal layer can be between the second part of the fifth planar coil and the second portion of the third planar coil, a third set of strips of the second metal layer can be between the third part of the third planar coil and the third portion of the third planar coil, and a fourth set of strips of the second metal layer can be between the fourth part of the fourth planar coil and the fourth portion of the fourth planar coil. A first strip of the first set of strips can be coupled to a second strip of the third set of strips, a third strip of the second set of strips can be coupled to a fourth strip of the second set of strips, and the third coupling can be between the first strip and the second strip and inductively couples the first strip to the second strip.

The first planar coil can mirror the fifth planar coil between the first RF port and the fourth RF port, and the second planar coil can mirror the sixth planar coil between the second RF port and the third RF port.

The third planar coil can mirror the fourth planar coil.

The first planar coil can be in an octagonal or a substantially octagonal pattern.

A radio frequency signal input at the first RF port can result in an instance of the radio frequency signal output at the second RF port, and a ninety-degree phase shifted instance of the radio frequency signal output at the third RF port.

One or more example embodiments and/or implementations can be embodied in a quadrature coupler, such as described and represented herein. The quadrature coupler can include an upper metal layer including a first radio frequency (RF) port coupled to a first planar coil, a third RF port coupled to a second planar coil, a fourth RF port coupled to a third planar coil, and a second RF port coupled to a sixth planar coil. The quadrature coupler can include an middle metal layer including a first interconnect that electrically couples the first RF port to the first planar coil, a second interconnect that electrically couples the third RF port to the second planar coil, a third interconnect that electrically couples the fourth RF port to the fifth planar coil, a fourth interconnect that electrically couples the second RF port to the sixth planar coil, a fifth interconnect, and a sixth interconnect. The middle metal layer can include a first strip, a second strip, a third strip, a fourth strip, a fifth strip, a sixth strip, a seventh strip, an eighth strip, a ninth strip that electrically couples the second strip to the fourth strip, a tenth strip that electrically couples the fifth strip to the seventh strip, and an eleventh strip between the ninth strip and the tenth strip that inductively couples the ninth strip to the tenth strip. The quadrature coupler can include a lower metal layer including a third planar coil and a fourth planar coil. A first part of the first planar coil overlaps with a first portion of the third planar coil, and the first strip and the second strip can be between the first part and the first portion at the middle metal layer. A second part of the fifth planar coil overlaps with a second portion of the third planar coil, and the fifth strip and the sixth strip can be between the second part and the second portion at the middle metal layer. A third part of the second planar coil overlaps with a third portion of the fourth planar coil, and the third strip and the fourth strip can be between the third part and the third portion at the middle metal layer. A fourth part of the sixth planar coil overlaps with a fourth portion of the fourth planar coil, and the seventh strip and the eighth strip can be between the fourth part and the fourth portion at the middle metal layer. The fourth planar coil can be electrically coupled to the first planar coil and the second planar coil via the fifth interconnect of the middle metal layer, and the third planar coil can be electrically coupled to the fifth planar coil and the sixth planar coil via the sixth interconnect of the middle metal layer.

The first planar coil can mirror the fifth planar coil in a first dimension between the first RF port and the fourth RF port, the first planar coil can mirror the second planar coil in a second dimension that can be perpendicular to the first dimension, the sixth planar coil can mirror the second planar coil in the first dimension, the first planar coil can mirror the second planar coil in the first dimension, the sixth planar coil can mirror the fifth planar coil in the second dimension, and the third planar coil can mirror the fourth planar coil in the second dimension.

The first RF port can be an input port, the second RF port can be a direct port, the third RF port can be a coupled RF port, and the fourth RF port can be an isolated RF port.

As can be seen, the technologies described herein are directed to a transformer-based quadrature coupled enhanced coupling strength in which the integration of middle-layer metal strips significantly boosts the transformer's coupling efficiency. In one implementation, described is a design with a cost-effective device compatible with common manufacturing processes, in contrast to prior designs that rely on using advanced materials.

The design achieves a balance between size and performance, operating efficiently in the 5-6 GHz range. The technologies described herein align with existing RF and microwave design workflows, making implementation for end users straightforward. The design's compatibility with standard printed circuit board technology makes the quadrature coupler device suitable for a wide range of commercial and industrial wireless systems. In general, the design delivers improved performance in terms of bandwidth and coupling strength, making it a suitable solution for modern wireless communication systems that desire compact, efficient, and manufacturable components.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component can be an apparatus with specific functionality provided by mechanical parts operated by electric or electronic circuitry. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A quadrature coupler, comprising:
a first radio frequency (RF) port, a second RF port, a third RF port, and a fourth RF port,
an upper metal layer, a lower metal layer, and a middle metal layer between the upper metal layer and the lower metal layer;
a first section, comprising:
a first planar coil on the first metal layer, the first coil planar coil comprising a first inner end and a first outer end, wherein the first planar coil is coupled to the first port via a first interconnected portion of the second metal layer, and
a second planar coil on the first metal layer, the second coil planar coil comprising a second inner end and a second outer end, wherein the first planar coil is electrically coupled to the second planar coil at the first outer end of the first planar coil and the second outer end of the second planar coil, and wherein the second planar coil is coupled to the third port via a second interconnected portion of the second metal layer;
a third section, comprising:
a fifth planar coil on the first metal layer, the fifth coil planar coil comprising a fifth inner end and a fifth outer end, wherein the fifth planar coil is coupled to the fourth port via a fifth interconnected portion of the second metal layer, and
a sixth planar coil on the first metal layer, the sixth coil planar coil comprising a sixth inner end and a sixth outer end, wherein the fifth planar coil is electrically coupled to the sixth planar coil at the fifth outer end of the fifth planar coil and the sixth outer end of the sixth planar coil, and wherein the sixth planar coil is coupled to the second port via a sixth interconnected portion of the second metal layer; and
a second section, comprising:
a third planar coil on the third metal layer, the third planar coil comprising a third inner end and a third outer end, wherein the third outer end of the third planar coil is electrically coupled to the fifth outer end of the fifth planar coil and the sixth outer end of the sixth planar coil via a seventh interconnected portion of the second metal layer; and
a fourth planar coil on the third metal layer, the fourth planar coil comprising a fourth inner end and a fourth outer end, wherein the fourth outer end of the fourth planar coil is electrically coupled to the first outer end of the first planar coil and the second outer end of the second planar coil via a third interconnected portion of the second metal layer, and wherein the third inner end of the third planar coil is electrically coupled to the fourth inner end of the fourth planar coil via a fourth interconnected portion of the second metal layer,
wherein the first planar coil overlaps and is inductively coupled to the third planar coil at a first overlapping region, and wherein a first non-interconnected portion of the second metal layer and a second non-interconnected portion of the second metal layer are between the first planar coil and the second planar coil at the first overlapping region,
wherein the second planar coil overlaps and is inductively coupled the fourth planar coil at a second overlapping region, and wherein a third non-interconnected portion of the second metal layer and a fourth non-interconnected portion of the second metal layer are between the second planar coil and the fourth planar coil at the second overlapping region,
wherein the fifth planar coil overlaps and is inductively coupled to the third planar coil at a third overlapping region, and wherein a fifth non-interconnected portion of the second metal layer and a sixth non-interconnected portion of the second metal layer are between the fifth planar coil and the third planar coil at the third overlapping region;
wherein the sixth planar coil overlaps and is inductively coupled the fourth planar coil at a fourth overlapping region, and wherein a seventh non-interconnected portion of the second metal layer and an eighth non-interconnected portion of the second metal layer are between the sixth planar coil and the fourth planar coil at the second overlapping region,
wherein the second non-interconnected portion of the second metal layer is electrically coupled to the sixth non-interconnected portion of the second metal layer and, and
wherein the third non-interconnected portion of the second metal layer is electrically coupled to the seventh non-interconnected portion of the second metal layer.

2. The quadrature coupler of claim 1, wherein the first section is substantially identical to the third section.

3. The quadrature coupler of claim 1, wherein the first RF port comprises an input port, the second RF port comprises a direct port, the third RF port comprises a coupled RF port, and the fourth RF port comprises an isolated RF port.

4. The quadrature coupler of claim 1, wherein the second metal layer is below the first metal layer level, and wherein the third metal layer level is below the second metal layer level.

5. The quadrature coupler of claim 1, wherein the first section has an even mode impedance around 68.5 ohms, and an odd mode impedance around 44.4 ohms, and wherein the second section has an even mode impedance around 164.2 ohms, and an odd mode impedance of about 12.7 ohms.

6. The quadrature coupler of claim 1, wherein the first section has a coupling coefficient around 0.122, and wherein the second section has a coupling coefficient of about 0.973.

7. The quadrature coupler of claim 1, wherein the first section has an inductance around 0.8 nanohenries, and wherein the second section has an inductance of about 0.2.7 nanohenries.

8. The quadrature coupler of claim 1, wherein the first section has a ground capacitor having a first capacitance around 1.2 femtofarads, and a mutual coupling capacitor having a second capacitance of about 0.8 or 0.9 femtofarads.

9. The quadrature coupler of claim 1, wherein the second section has a capacitance of about 1.3 femtofarads.

10. The quadrature coupler of claim 1, wherein the quadrature coupler has a bandwidth of about one gigahertz.

11. The quadrature coupler of claim 1, wherein the quadrature coupler has a center frequency between about five and six gigahertz.

12. The quadrature coupler of claim 1, wherein the quadrature coupler is incorporated into a Butler matrix.

13. A device, comprising:
a substrate;
a first metal level, a second metal level and a third metal level above the substrate; and
a radio frequency (RF) quadrature coupler, comprising:
a first RF port, a second RF port, a third RF port, and a fourth RF port;
a first planar coil, a second planar coil, a fifth planar coil and a sixth planar coil on the first metal level,
wherein the first planar coil is coupled to the first port, the second planar coil is coupled to the third port, and the first planar coil is coupled to the second planar coil,
wherein the fifth planar coil is coupled to the fourth port, wherein the sixth planar coil is coupled to the second port, and wherein the fifth planar coil is coupled to the sixth planar coil,
a third planar coil and a fourth planar coil on the third metal level,
wherein the third planar coil is coupled to the fourth planar coil via a first coupling of the second metal layer, wherein the fourth planar coil is coupled to the first planar coil and the second planar coil via a second coupling of the second metal layer, and wherein the third planar coil is coupled to the fifth planar coil and the sixth planar coil via a third coupling of the second metal layer,
wherein a first part of the first planar coil overlaps and inductively couples to a first portion of the third planar coil, and wherein a second part of the fifth planar coil overlaps and inductively couples to a second portion of the third planar coil,
wherein a third part of the second planar coil overlaps and inductively couples to a third portion of the fourth planar coil, and wherein a fourth part of the sixth planar coil overlaps and inductively couples to a fourth portion of the fourth planar coil,
wherein a first set of strips of the second metal layer is between the first part of the first planar coil and the first portion of the third planar coil, wherein a second set of strips of the second metal layer is between the second part of the fifth planar coil and the second portion of the third planar coil, wherein a third set of strips of the second metal layer is between the third part of the third planar coil and the third portion of the third planar coil, and wherein a fourth set of strips of the second metal layer is between the fourth part of the fourth planar coil and the fourth portion of the fourth planar coil, and
wherein a first strip of the first set of strips is coupled to a second strip of the third set of strips, wherein a third strip of the second set of strips is coupled to a fourth strip of the second set of strips, and wherein the third coupling is between the first strip and the second strip and inductively couples the first strip to the second strip.

14. The device of claim 13, wherein the first planar coil mirrors the fifth planar coil between the first RF port and the fourth RF port, and wherein the second planar coil mirrors the sixth planar coil between the second RF port and the third RF port.

15. The device of claim 13, wherein the third planar coil mirrors the fourth planar coil.

16. The device of claim 13, wherein the first planar coil is in an octagonal or a substantially octagonal pattern.

17. The device of claim 13, wherein a radio frequency signal input at the first RF port results in an instance of the radio frequency signal output at the second RF port, and a ninety-degree phase shifted instance of the radio frequency signal output at the third RF port.

18. A quadrature coupler, comprising:
an upper metal layer comprising:
a first radio frequency (RF) port coupled to a first planar coil, a third RF port coupled to a second planar coil, a fourth RF port coupled to a third planar coil, and a second RF port coupled to a sixth planar coil;
a middle metal layer comprising:
a first interconnect that electrically couples the first RF port to the first planar coil, a second interconnect that electrically couples the third RF port to the second planar coil, a third interconnect that electrically couples the fourth RF port to the fifth planar coil, a fourth interconnect that electrically couples the second RF port to the sixth planar coil, a fifth interconnect, and a sixth interconnect, and
a first strip, a second strip, a third strip, a fourth strip, a fifth strip, a sixth strip, a seventh strip, an eighth strip, a ninth strip that electrically couples the second strip to the fourth strip, a tenth strip that electrically couples the fifth strip to the seventh strip, and an eleventh strip between the ninth strip and the tenth strip that inductively couples the ninth strip to the tenth strip; and
a lower metal layer comprising:
a third planar coil and a fourth planar coil,
wherein a first part of the first planar coil overlaps with a first portion of the third planar coil, and wherein the first strip and the second strip are between the first part and the first portion at the middle metal layer,
wherein a second part of the fifth planar coil overlaps with a second portion of the third planar coil, and wherein the fifth strip and the sixth strip are between the second part and the second portion at the middle metal layer,
wherein a third part of the second planar coil overlaps with a third portion of the fourth planar coil, and wherein the third strip and the fourth strip are between the third part and the third portion at the middle metal layer,
wherein a fourth part of the sixth planar coil overlaps with a fourth portion of the fourth planar coil, and wherein the seventh strip and the eighth strip are between the fourth part and the fourth portion at the middle metal layer, and
wherein the fourth planar coil is electrically coupled to the first planar coil and the second planar coil via the fifth interconnect of the middle metal layer, and wherein the third planar coil is electrically coupled to the fifth planar coil and the sixth planar coil via the sixth interconnect of the middle metal layer.

19. The quadrature coupler of claim 18, wherein the first planar coil mirrors the fifth planar coil in a first dimension between the first RF port and the fourth RF port, wherein the first planar coil mirrors the second planar coil in a second dimension that is perpendicular to the first dimension, wherein the sixth planar coil mirrors the second planar coil in the first dimension, wherein the first planar coil mirrors the second planar coil in the first dimension, wherein the sixth planar coil mirrors the fifth planar coil in the second dimension, and wherein the third planar coil mirrors the fourth planar coil in the second dimension.

20. The quadrature coupler of claim 18, wherein the first RF port comprises an input port, the second RF port comprises a direct port, the third RF port comprises a coupled RF port, and the fourth RF port comprises an isolated RF port.
